(19) United States
(12) Patent Application Publication
(10) Pub. No.: US 2009/0213085 A1
(43) Pub. Date: Aug. 27, 2009

(54) Entering a Character into an Electronic Device

(75) Inventors: Li Xin Zhen, Shanghai (CN); Qing Shan Chen, Shanghai (CN); Bai Hua Xiao, Shanghai (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/091,332

(22) PCT Filed: Oct. 6, 2006
(86) PCT No.: PCT/US06/39330

§ 371 Date: Oct. 22, 2008

(30) Foreign Application Priority Data
Oct. 25, 2005 (CN) 200510116021.0

(51) Int. Cl. G06F 3/041

(52) U.S. Cl. 345/173

(57) ABSTRACT

The present invention provides a method (200) of entering characters into an electronic device (100). The method comprises receiving a number of scribed stroke samples (207) from a touch sensitive tablet (105) of the device, the scribed strokes corresponding to lines of one or more characters. Determining a character entry height (221) of a character entry scribing region (180) of the tablet dependent on the received scribed stroke samples. Determining a character entry speed for the character entry scribing region of the tablet dependent on the received scribed stroke samples (217). Scrolling the character entry scribing region on a display (105) of the device depending on the character entry speed.

### FIELD OF THE INVENTION

The present invention relates generally to the field of character input into an electronic device.

### BACKGROUND OF THE INVENTION

Portable handheld electronic devices such as handheld wireless communications devices (e.g. cellphones) that are easy to transport are becoming commonplace. Such handheld electronic devices come in a variety of different form factors and support many features and functions.

Cellular telephones, Personal Digital Assistants (PDAs), tablet computers and other similar portable electronic devices, and electronic devices in general, sometimes have an input tablet that is typically a touch screen providing a two-way user interface for data entry, invoking applications and menu traversing. Touch screens have evolved to allow a user to scribe and therefore input handwritten characters such as words, letters, alphanumeric strings, Asian characters (such as Chinese, Korean and Japanese characters) and other indicia into an electronic device. The electronic device then processes and compares the handwritten characters with characters stored in a recognition dictionary (memory), and identifies a best match. The best match may then invoke a command or identify the scribed characters as input data to the electronic device.

As these portable devices become smaller and more specialized, text input has become more difficult and less practical. Typical handwriting recognition software may require users to learn special characters or effect a handwriting style in order to enter text. Text input using the Graffiti(r) unistroke (i.e., written with a single pen trace) alphabet can be un-natural because it requires users to adhere to strict rules that restrict character shapes; text input using an on-screen QWERTY keypad is difficult because of the small size of the individual keys.

Handwriting recognition (HWR) programs capable of dealing with natural (i.e., unrestricted in style) handwritten input are being developed to add to the function and usefulness of PDAs and are important to the growth of mobile computing in the communications field. Handwriting recognition software, such as Transcriber (formerly known as CalliGrapher) from Microsoft Corp., allows the user to write anywhere on the screen, including on top of other displayed application and system elements. After a time-out period following a pen-lift, the digital ink is removed from the screen and then recognized, the recognition results are then displayed on the screen as ASCII text, and the next sentence or string of words can be handwritten on the screen. However HWR such as Transcriber allow users to write two or three lines at a time at most, with at best two or three words each, which limits entry and prevents continuous uninterrupted longhand entry. Further, these write-anywhere interfaces are problematic because it is difficult to differentiate whether the stylus is acting as a pointer, for clicking on application icons and the like, or an inking instrument for text entry. A common solution involves an un-natural “tap and hold” scheme wherein the pen has to be maintained down without dragging it for a certain amount of time in order to get the stylus to act temporarily as a mouse. This can lead to text input errors and the attendant aggravation and input delays caused by such errors.

Another problem with a write-anywhere user interface is that fingers, as the writer is moving his/her hand through the screen, can often interfere with the (pressure-based) pen tracking mechanism. Simultaneous pressure from the stylus and a carelessly positioned pinky finger can cause the device to mislocate the intended stylus entry point, e.g., the device may use the average of the two contact locations. One solution to these problems has been to provide a special area at the bottom of the screen which is reserved for handwritten input. Typically one word is input at a time then recognized. However in another solution provided by Motorola Inc., a similar special area at the bottom of the screen is made to scroll in the opposite direction to that of the user's writing, thereby offering a “continuous” writing strip.

### SUMMARY OF THE INVENTION

In general terms in one aspect the present invention provides a method of entering characters into an electronic device in which a continuous or scrolling writing strip is provided anywhere on a touch sensitive tablet such as a touch screen in response to a user starting to write at that location. The method receives a number of scribed stroke samples such as ink points and from these determines a character entry height for a character entry scribing region or writing strip, together with a character entry speed. The character entry scribing region defined by the character entry height is then scrolled depending on the character entry speed.

This method allows a user to start writing at any point on the tablet or touch screen, and by determining the first few samples of the users writing or scribing, defining a scrolling continuous scribing strip for the user to keep entering characters and words, rather than have to stop after one or two words for a recognition step. The recognition step can instead be continuously carried out as the user continues to enter new words. This speeds up user data entry into small screen devices, and provides a more natural or familiar user entry interface.

In an embodiment, the direction of the writing strip can be defined depending on the character or data entry mode. For example, selecting an English character entry mode can be used to set the direction horizontally across the screen (left to right) whereas a Chinese character entry mode selection can be used to set the writing strip direction vertically down the screen (top to bottom). The method then determines the height or width of the users scribed strokes over an initial period, and sets an initial height or width for the scrolling strip.

The strip can then be used for scribed data entry, whereas the regions outside the scribing strip can be used for displaying a non-data entry application interface, for example buttons for controlling another applications, or perhaps for terminating the character entry region or strip. This overcomes the problem of determining which actuations of the touch sensitive tablet or screen are intended as scribed data entry and which are intended as application control commands for an underlying application for example. Furthermore the scrolling writing strip provides speed of data entry and user-friendliness interface advantages.

In another embodiment, the method determines a character entry direction for the character entry region or writing strip from the initial scribed input samples. This allows a user to write or scribe across the touch sensitive tablet in any direction convenient to the user.

In an embodiment, the character entry direction is achieved by first determining a character entry angle by using bounding boxes at different orientation angles around the scribed input samples. The orientation angle of the bounding box having the largest aspect ratio can then be determined as the writing angle. In an alternative or complimentary method, the distribution of lateral samples from a centre line of the samples at different orientation angles can be used. Once the character entry angle has been determined, one or more initial and final sample locations can be used to determine the direction from the two possibilities given by the angle.

In this embodiment, the character entry height for the character entry region can be determined from a centre line of the samples at the character entry angle, and adjusting the height until the laterally most extreme samples (or a proportion of these) are included within the writing strip or region. Alternatively the largest lateral span of scribed stroke samples with respect to the orientation or character entry angle can be used.

The scribing entry region or strip can be continuously adjusted for changes in the users scribing speed, height and or direction, by periodically taking new scribed input samples. The number of samples required for each iteration can also be adjusted according to the size of the previously determined character entry region. In an embodiment, the character entry height is multiplied by PI to determine the number of samples required for the next iteration.

In another aspect there is provided a method of entering characters into an electronic device, the method comprising: receiving a number of scribed stroke samples from a touch sensitive tablet of the device, the scribed strokes corresponding to lines of one or more characters; determining a character entry direction for a character entry scribing region of the tablet dependent on the received scribed stroke samples; determining a character entry speed for the character entry scribing region of the tablet dependent on the received scribed stroke samples; scrolling the character entry scribing region on the tablet of the device depending on the character entry speed.

This method may be supplemented by determining a character entry height of a character entry scribing region of the tablet dependent on the received scribed stroke samples.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with the invention;

FIG. 2 shows a touch sensitive tablet or display screen having a scrolling character entry scribing region according to an embodiment;

FIG. 3 is a flow chart illustrating a method for implementing the scrolling scribing region of FIG. 2;

FIG. 4 shows bounding boxes for a number of scribed input samples;

FIG. 5 shows different aspect ratios for bounding boxes bounding scribed input samples rotated 90 degrees with respect to each other;

FIG. 6 illustrates bounding rectangles and boxes for scribed input samples at different orientation angles;

FIG. 7 illustrates a lateral displacement distribution of samples for an orientation angle;

FIG. 8 illustrates lateral displacement distributions of samples for a number of orientation angles;

FIG. 9 illustrates initial and final samples for received scribed input samples for determining writing direction;

FIG. 10 illustrates the writing distance of received scribed input samples;

FIG. 11 illustrates the writing size or character entry height of scribed input samples; and

FIG. 12A-12D illustrate screen shots for another embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to scrolling scribed character entry into an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of scrolling scribed character entry into an electronic device described herein. The non-processor circuits may include, but are not limited to, a radio receiver, a radio transmitter, signal drivers, clock circuits, power source circuits, and user input devices. As such, these functions may be interpreted as steps of a method to perform scrolling scribed character entry into an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

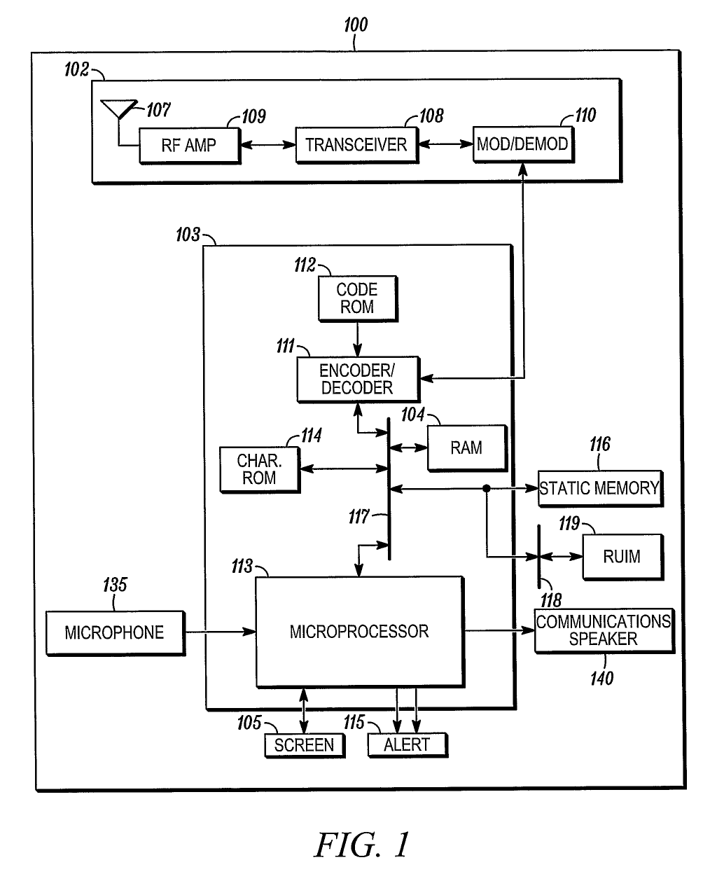

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a touch sensitive tablet or display screen 105 such as a touch screen. There is also an alert module 115 that typically contains an alert speaker, vibrator motor and associated drivers. The display screen 105, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the display screen 105, and the alert module 115. Also, micro-processor 113 has ports for coupling to a microphone 135 and al communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

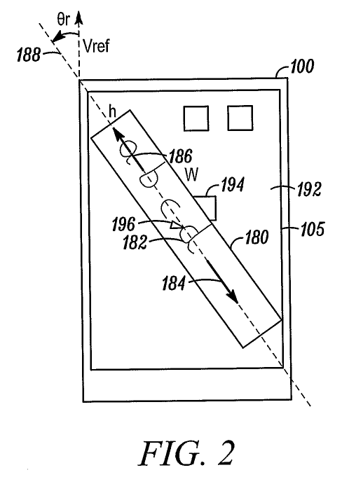

FIG. 2 shows the touch sensitive table or display screen 105 illustrating a method of entering characters into an electronic device according to an embodiment. The method provides a scrolling writing strip or character entry scribing region 180 on the display screen 105, which can be located anywhere on the screen, have any writing angle, and any size; depending on the user's initial writing or scribing input. Thus the method provides a “write anywhere” type of scribing interface in which a scribing strip is defined and displayed in the foreground of the display screen.

The method captures samples of the users scribed strokes 182. The scribed strokes correspond to lines of one or more characters, and may be scribed using a stylus tip 196 as indicated, or a finger for example. The method uses the scribed stroke samples or ink points 182 to determine the direction 184 of the writing or scribing, the height h of the scribed characters, and the speed of scribing in the scribing direction 184. These input parameters are used to define the size (h×w) and orientation angle 190 of the character entry scribing region 180, and to set it scrolling in the opposite direction 186. The orientation angle 190 may be relative to any convenient base axis, for example the vertical of the display screen 105. The figure also shows a centre line 188 which is h/2 from each edge of the writing strip 180, and a width w of the writing strip 180.

The writing strip or character entry scribing region 180 is overlaid on another background screen 192 which may be another application, or part of the same character entry application as the writing strip 180. Any contact by the stylus 196 with the touch sensitive tablet or display screen 105 within the character entry scribing region 180 is interpreted as a scribed entry. Any contact by the stylus 196 with the touch screen 105 outside the character entry region 192 is not entered as scribed input, and may be used to actuate buttons 194 on the underlying screen display 192. This means that there is no confusion as to whether a stylus or finger contact is intended as a scribed entry or another entry, such as actuation of a soft button.

Furthermore, by determining the height h of the character entry scribing region 180 using the scribed input samples, a canvas or character entry scribing region can be provided which is appropriately sized to the users writing style. Typically the width w of the scribing region 180 will be sized to maximise the scribing region area (h×w) for the user, although other widths could alternatively be used, perhaps depending on the application. In the embodiment, the writing or character entry direction 184 is also determined by the received scribed samples, however this need not be the case and the direction may be set according to the particular character entry mode selected, for example English or Chinese characters.

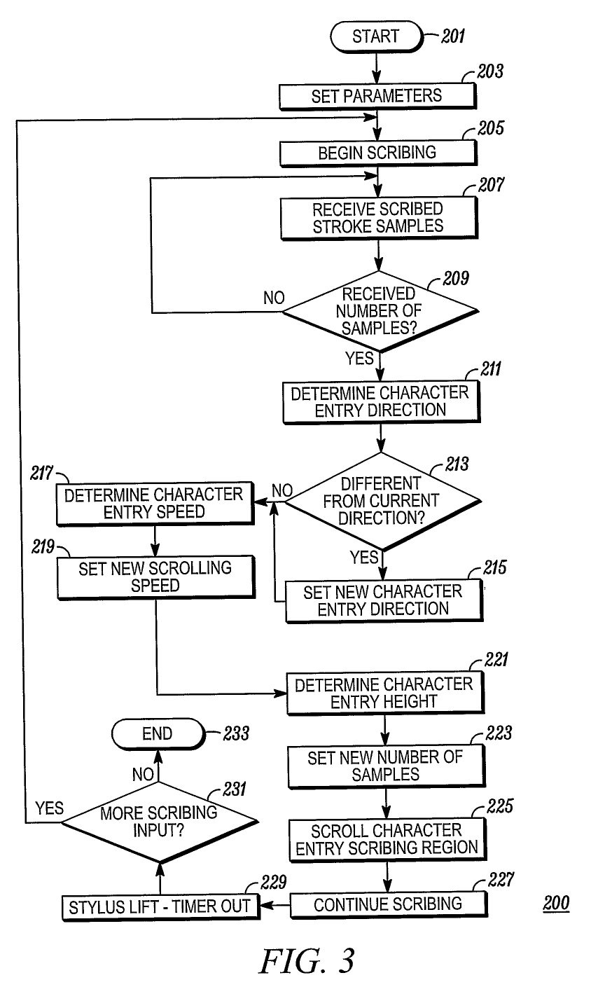

FIG. 3 illustrates a method (200) of entering characters into an electronic device in order to provide the scrolling canvas or character entry scribing region 180 of FIG. 2. Following an initial user selection (201) of the method, a number of parameters are initialised and in some cases set (203). The following parameters are used:
mDirection—the orientation or character entry angle of the scrolling writing strip in 360 degrees (also shown as θd)
θc—character entry angle or orientation in 180 degrees
mSpeed—the move speed of the scrolling writing strip or input canvas
mNumOfPts—the number of ink points or samples required to determine the writing direction, speed and height
moveTimeOut—the time interval to write a distance associated with the sample points
writingSize—the size of the canvas or writing strip; height by width (h*w)
THRESHOLD_DIRECTION_DIFF—threshold difference between current and new mDirection before new mDirection set
Hr, Wr—height and width of bounding rectangle
θr—orientation angle of bounding rectangle
Hb, Wb—height and width of bounding box
θb—orientation angle of bounding box
Vwriting—speed of character entry scribing
Vcanvas—speed of scrolling writing strip

The initial speed of the canvas or character entry scribing region 180 is zero, and the initial canvas or character entry height is typically set at ⅓ of the full tablet or screen height. Other initial canvas sizes could be used, for example the full screen height. This gives an initial mNumOfPts or number of samples to determine the parameters of the canvas. These are adjusted in further iterations of determining the canvas parameters.

Following initial scribing or writing by the user of the device (205) in the (initial) character entry scribing region, the method continues receiving ink points or scribed stroke samples (207) from the touch sensitive tablet or display screen 105 until a number (mNumOfPts) of samples have been received (209Y). The scribed strokes correspond to one or more lines of one or more characters. The method (200) then determines the character entry direction 184 using the received samples (211); and this is described in more detail below.

The method then determines whether the newly determined character entry (writing) direction 184 is different from the current writing direction (213). This is determined using the threshold parameter THRESHOLD_DIRECTION_DIFF, so that if the orientation angle difference between the old and new direction is greater than this parameter (213Y), the method sets a new character entry direction (215). This is illustrated by the equation:

|newDirection−currentDirection|>THRESHOLD_DIRECTION_DIFF;

where newDirection and currentDirection are angular values in degrees relative to a vertical reference line Vref and the THRESHOLD_DIRECTION_DIFF is typically an angular value between 5 to 20 degrees.

The method then determines a character entry speed (Vwriting) for the character scribing region dependent on the received scribed stroke samples (217). This is the distance along the character entry direction from an initial scribing sample to a final scribing sample in a given time; as described in more detail below. The character entry scribing region 180 can then be scrolled in the opposite direction 186 to the character entry direction 184 at the character entry speed (219). Alternatively a different scrolling speed (Vcanvas) could be used which is dependent on the writing speed (Vwriting). This means that once the character scribed entry region parameters (height h, width w, orientation angle θr) have been determined following receipt of enough scribed samples, the user can maintain their stylus or finger in roughly the same location on the screen whilst scribing; as the speed of the canvas matches that of the user. Furthermore, the user need not stop at the end of the canvas and await word or character recognition, as the canvas is continuous in the sense that new canvas keeps scrolling onto the screen for scribing.

The method (200) then determines the writing size or character entry height h (221) of the character entry scribing region dependent on the received scribed stroke samples. This is typically sized to include within the character entry scribing region 180 all the scribed input samples received, although these may be filtered to remove the effect of any extremely located samples. Once the character entry height h has been determined, the number of samples mNumOfPts can be calculated (223) for the next iteration of determining the character entry scribing region 180. Thus the size of the writing strip 180, and its scrolling speed can be adjusted to accommodate changes in user scribing input.

Having determined the character entry scribing region dimensions, and the speed of the user writing, the scribing region 180 is scrolled on the tablet (eg touch screen) depending on the character entry speed. Typically the scribing region 180 can be overlaid any background display 192 on the screen 105, and set scrolling in the opposite direction to the user's scribing input (225). The user then continues to scribe on the scrolling writing strip (227). A pen-lift and time-out mechanism can be used to detect the end of a scribed character or word in order to invoke a recognition engine (229). Any recognised characters or words may be displayed on another part of the screen 192. If further scribed strokes are recognised (231Y), the method returns to begin receiving the scribed samples (205), and the character entry scribing region 180 may be re-sized or re-orientated as a result of repeating the above described process. If no further scribed input is detected (231N), then the method ends (233).

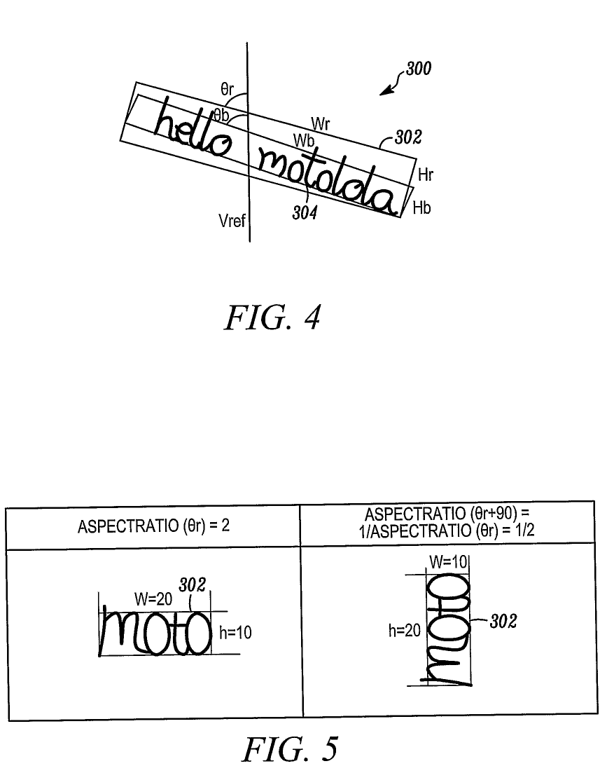

FIGS. 4, 5 and 6 illustrate a method of determining a character entry angle (190 in FIG. 2) for the determining the writing direction step (211) of FIG. 3. The method determines the aspect ratios of a number of bounding boxes bounding the received scribed stroke samples for a number of orientation angles. FIG. 4 shows a scribed entry 300 having a number of samples or ink points. A bounding rectangle 302 is orientated at a bounding rectangle orientation angle Or relative to the vertical reference line Vref, and is sized in order to accommodate all the scribed input samples. The initial bounding rectangle 302 therefore has a height Hr and a width Wr. These dimensions shouldn't be confused with the height and width parameters for the character entry scribing region 180 (w,h) mentioned above, and are only used for this method of determining the character entry angle.

Once a bounding rectangle 302 is determined for a particular orientation angle θr, a bounding box 304 is determined. Thresholds are used to determine how many of the samples are used for sizing the bounding box 304. For example if the threshold is 90%, the 10% of samples with the largest or most extreme dimensions are ignored, so that a compact distribution of the samples is relied on. This means for example that the dot of an “i” may be ignored, especially if it is well above the average height of the other scribed samples.

In another arrangement the thresholds are determined depending on the received samples as follows:
Wrthreshold=mNumOfPts/Wr
Hrthreshold=mNumOfPts/Hr
   The bounding rectangle is then adjusted to form the bounding box 304 by ignoring samples having a value greater than Wrthreshold or Hrthreshold from a respective Wr or Hr centre line of the scribed samples 300 at the current bounding rectangle orientation angle θr. The bounding box has a height Hb, a width Wb, and an orientation angle θb, which may be different from the respective bounding rectangle orientation angle θr.

The aspect ratio AR of the bounding box 304 is then calculated as AR(θr)=Wb/Hb. The aspect ratio for another orientation angle (θr₂) can then be determined using the above process. Either the bounding rectangle can be rotated, or the sampled image 300 according to the following equations:

x′=x*cos(θ)−y*sin(θ)

y′=x*sin(θ)+y*cos(θ)

where x and y are the original or previous coordinates, and x′ and y′ are the new coordinates after rotation by angle θ, which is the difference between the previous bounding rectangle or scribed samples rotation angle and the new rotation angle.

In practice, aspect ratios AR need only be calculated for a range of orientation angle θr=0 to 90. The aspect ratios for angles θr=90 to 180 can then be simply calculated according to:

AspectRatio(θr+90)=1/AspectRatio(θr)

For example referring to FIG. 5, it can be seen that for an orientation angle θr, w=20 and h=10, giving an aspect ratio of 2. For the orientation angle of θr+90, the dimensions are reversed giving an aspect ratio of 0.5.

The character entry angle θc is then determined as the orientation angle (θr) within the range 0-180 having the largest aspect ratio. The character entry direction θd is then determined from the character entry angle θc and the order over time of the samples to give the direction in 360 degrees.

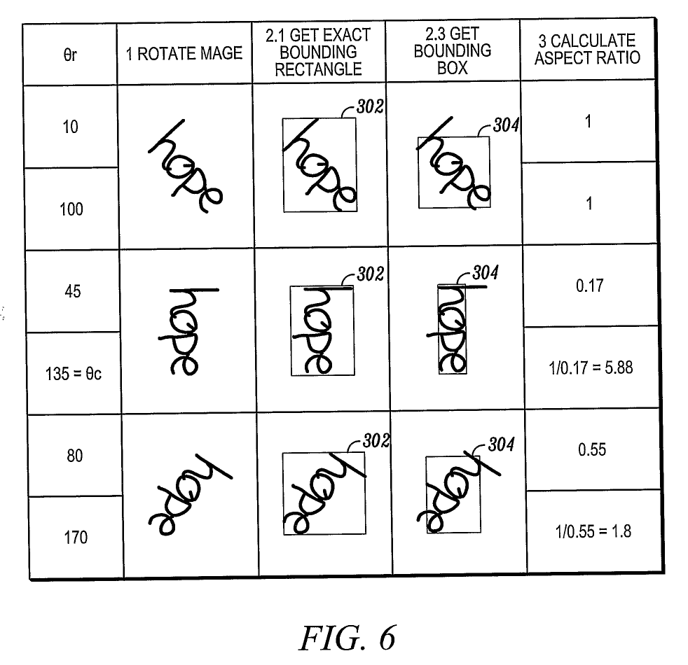

FIG. 6 illustrates an example of orientating an image or scribed sample 300 for a number of orientation angles θr, obtaining a bounding rectangle 302, from this obtaining a bounding box 304, and from this obtaining aspect ratios for θr and θr+90. The largest aspect ratio AR=5.88 is for θr=135, thus this is determined as the character input angle θc.

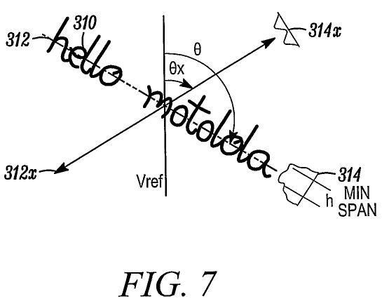

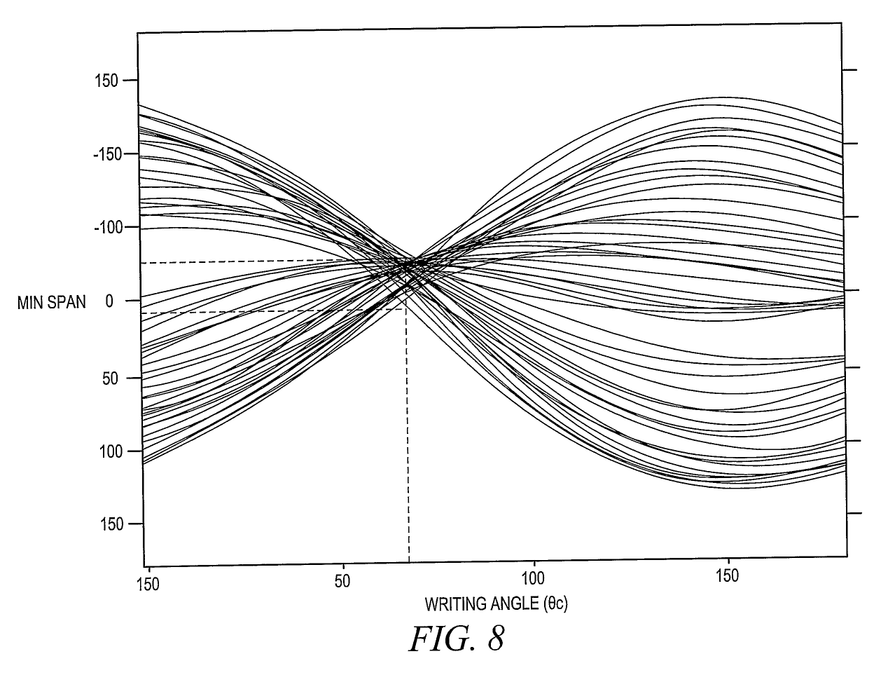

FIGS. 7 and 8 illustrate an alternative method of determining the character entry angle. This method may also be used in addition to the method of FIGS. 4, 5, and 6, for example by averaging the results. FIG. 7 illustrates scribed text samples 310 (often referred to as samples of electronic ink points) orientated at an orientation angle θ. A centreline 312 is shown, which equally divides the samples in the character height h direction. Also shown is a distribution graph 314 of scribed text samples against height h or the lateral direction. As shown in the distribution graph 314 most of the samples are close to the centreline 312, with fewer samples away from the centreline. In this example, the centreline 312 coincides with the centreline of the scribed words 310, and so the lateral distribution of samples or ink points is compact. It can be seen that if the scribed words or image 310 was rotated with respect to the vertical reference line Vref at an angle corresponding to an orientation angle θx, the distribution of lateral samples would disperse as more and more samples extended well beyond the centreline 312, and fewer and fewer samples remained close to the centreline 312. This can be seen by comparing the height of samples above the dashed centreline 312x at the orientation angle θx. The distribution of lateral points shown in distribution graph 314x for this orientation is much more widely dispersed. This observation can be used to determine the character entry angle or character writing angle θc, by looking for the distribution of lateral scribed stroke samples with the most compact distribution of samples or lowest standard deviation for a number of angles (0-180) relative to the vertical reference line Vref.

Alternatively, the method may simply determine the maximum span in opposite height directions h between the highest and lowest samples of the received scribed samples 310. In another example, the least extreme (90%) samples could be used in each case in order to filter out unusual effects.

FIG. 8 illustrates a graph showing the span between extreme samples for a number of orientation angles (θ=0-180). It can be seen that the minimum span is at an orientation angle of θ=60. This corresponds to most of the ink samples being close to the centre line, such as in the example of angle θ in FIG. 7. This compares with values of θ such as angle θx from FIG. 7 in which the ink samples show a wide distribution. The orientation angle θ with the minimum span is then taken as the character writing angle or character entry angle θc that is the minimum span of the distribution of samples for a centreline for a selected orientation angle θ.

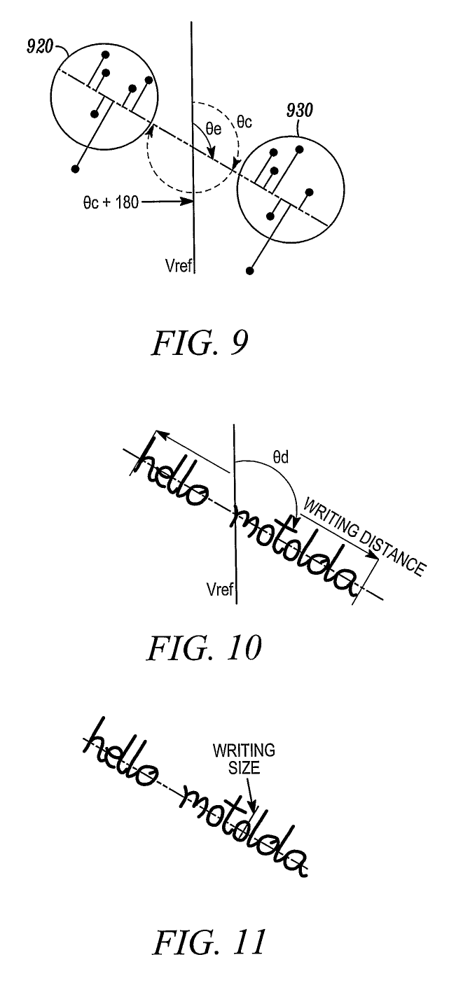

FIG. 9 illustrates a method for detecting the character entry direction. The character writing angle or character entry angle provides two possible directions, θc and θc+180. In order to determine which angle is the character entry direction θd, the first five samples 920 and the last five samples 930 are determined. The coordinates of these two groups of samples are averaged, and the direction determination angle θe of a line between them determined. This direction determination angle θe is compared to the character entry angle θc and θc+180 (these are shown dashed for comparison), and the closer of the two is used to assign the appropriate character entry angle as the character entry direction (angle θd=θc or θc+180). Averaging a group of initial and final samples is used in order to reduce the effect of extreme initial or final scribed stroke samples; and any suitable number of samples could be used.

FIG. 10 illustrates the writing distance of received scribed input samples used to determine the character entry speed. This speed is determined by obtaining the writing distance in the writing direction or character entry direction θd divided by the period of time over which the number of samples were received—the moveTimeOut. This can then be used as the scrolling speed, though in the opposite direction (θd+180). The writing distance is the bounding rectangle width Wr as described above.

The writing or character entry speed contains two parts: the canvas or character entry scribing region moving speed and the pen or stylus moving speed. To let the canvas or character entry scribing region 180 move at a speed related to the pen move speed, the ratio between canvas move speed and pen move speed is set to 1:2. In other words, the speed of the character entry scribing region (canvas) is ⅓ of writing speed.

Thus character entry speed (writing speed)=character entry scribing region speed (Vcanvas)+stylus moving speed (Vpen)

Then Vcanvas=1/k*writing speed*moveTimeOut

where k=3. So in every speed measurement time interval (moveTimeOut)—the time to receive all the samples, the canvas move distance is ⅓ of the writing distance.

FIG. 11 illustrates the writing size or character entry height h of the character entry scribing region which is sized to include all of the received samples. The character entry height is determined as the span of scribed strokes in a direction perpendicular to the character entry direction (θd+90). This may be achieved by determining the two most extreme samples in that height direction, and determining their span or distance as the character entry height. Alternatively a centreline may be determined which divides the received samples in two, and the sample having the most extended height is determined. The character entry scribing region may then be made to have a character entry height of twice this extended height. The character entry height may also be determined as part of the bounding box determining method of FIGS. 4, 5, and 6; thus the character entry height is Hb.

The character entry scribing region or canvas can then be displayed on the screen and made to scroll at a scrolling speed (Vcanvas), which is dependent on the character entry speed. As more scribed samples are received, further iterations of the method for determining the direction, height and speed of character entry can be calculated. The number of samples (mNumOfPts) required to perform these calculations depends on the size of the scribed strokes. Thus if the size of the user writing increases, so should the number of samples used to perform the calculations. This is because the sample size or pixels of the tablet remain the same, irrespective of user scribed input.

The number of samples or ink points in a line or stroke is dependent on the sampling interval (SI) of the tablet, for example SI=0.5 mm. The number of samples or points in a line extending the height h of the character entry scribing region is then h/SI. Using the assumption that the number of points or samples in a character is similar to that in a circle of the same height/diameter, we can obtain the number of points in a character as PI*h/SI, where PI=3.1415926. Finally the number of points or samples to use for the next iteration can be determined from the number of characters typically entered into the character scribing region in order to provide adequately accurate results; typically this number n=2 to 4. This is an experimental value, and may vary in different circumstances. Thus:

mNumOfPts=n*PI*h/SI

As noted above, for the first iteration, a sample number calculated according to a writing height h of ⅓ of the full screen height can be used. The character entry scribing region will then reduce to an appropriate height after the first number of received scribed sample are received and processed.

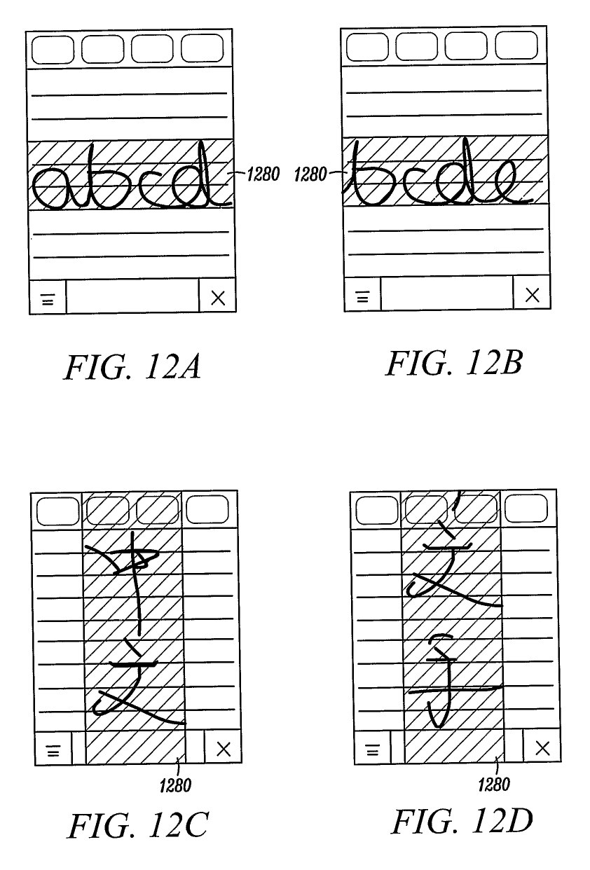

FIG. 12A-12D illustrate another embodiment in which the character entry direction is set according to the character entry mode. For example as shown in FIGS. 12a and 12b, the character entry mode is English characters which are normally written horizontally from left to right across the tablet or screen. By contrast, FIGS. 12c and 12d show a Chinese character entry mode in which the characters are typically written from the top of the tablet or touch screen to the bottom. Another example is Hebrew, which is traditionally written horizontally, but from right to left. Thus the direction of the scrolling character entry scribing region 1280 can be set by the language that the data entry program of an electronic device is set to recognise.

With the character entry direction already determined, the method can be arranged to determine the character entry speed and character entry height according to the methods described in the previous embodiment. Once the received samples are so processed, the character entry scribing region 1280 is displayed as shown in FIG. 12 and scrolled in the opposite direction to the character entry direction, and at a speed according to the character entry speed as discussed above.

In a further alternative, the character entry direction may be determined from the received scribed stroke samples, but the character entry height may not be. For example the height may be predetermined, for example 1.5 cm, or the entire screen display may be made to scroll in the direction opposite to the character entry direction. The methods described above may be used for determining the character entry direction and character entry speed for scrolling the display.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

We claim:

1. A method of entering characters into an electronic device, the method comprising:
receiving a number of scribed stroke samples from a touch sensitive tablet of the device, the scribed strokes corresponding to lines of one or more characters;
determining a character entry height of a character entry scribing region of the tablet dependent on the received scribed stroke samples;
determining a character entry speed for the character entry scribing region of the tablet dependent on the received scribed stroke samples;
scrolling the character entry scribing region on the tablet of the device depending on the character entry speed.

2. A method of entering characters into an electronic device as claimed in claim 1, wherein a character entry direction is determined in response to a user mode selection.

3. A method of entering characters into an electronic device as claimed in claim 1, wherein a character entry direction is determined dependent on the received scribed strokes samples.

4. A method of entering characters into an electronic device as claimed in claim 5, further comprising determining a character entry angle by calculating aspect ratios of bounding boxes of the received scribed stroke samples for a number of orientation angles.

5. A method of entering characters into an electronic device as claimed in claim 4, wherein height and width parameters for the bounding boxes are determined from the sum of the scribed stroke samples divided by the number of scribed stroke samples to the most extremely displaced scribed stroke sample from a centre point of the bounding box in each respective height or width direction.

6. A method of entering characters into an electronic device as claimed in claim 3, further comprising determining a character entry angle according to the distribution of lateral scribed stroke samples from a centre line of the received scribed stroke samples for a number of orientation angles.

7. A method of entering characters into an electronic device as claimed in claim 6, determining the character entry direction from the character entry angle and a beginning and an ending scribed stroke sample.

8. A method of entering characters into an electronic device as claimed in claim 1, wherein the character entry height is determined from a centre line in a character entry direction of the received scribed stroke samples and such that the character entry scribing region encompasses all of the scribed strokes samples.

9. A method of entering characters into an electronic device as claimed in claim 1, wherein the number of scribed strokes samples is dependent on PI and a character entry height of a previously determined character entry scribing region.

10. A method of entering characters into an electronic device as claimed in claim 1, wherein the touch sensitive tablet comprises one or more non-scribing regions for receiving non-scribed user input.

11. A carrier medium for carrying processor code which when run on a processor carries out the method of claim 1.

12. An electronic device comprising:
a touch sensitive tablet arranged to receive a number of scribed stroke samples corresponding to lines of one or more characters;
a processor arranged to scroll a character entry scribing region on the tablet in response to determining a character entry speed and a character entry height dependent on the scribed stroke samples received from the tablet.

13. An electronic device as claimed in claim 12, wherein the processor is further arranged to determine a character entry direction for the character entry scribing region in response to a user mode selection.

14. An electronic device as claimed in claim 12, wherein the processor is further arranged to determine a character entry direction for the character entry scribing region dependent on the received scribed strokes samples.

15. An electronic device as claimed in claim 14, wherein the processor is further arranged to determine a character entry angle by calculating aspect ratios of bounding boxes of the received scribed stroke samples for a number of orientation angles.

16. An electronic device as claimed in claim 14, wherein the processor is further arranged to determine a character entry angle according to the distribution of lateral scribed stroke samples from a centre line of the received scribed stroke samples for a number of orientation angles.

17. An electronic device as claimed in claim 16, wherein the processor is further arranged to determine the character entry direction from the character entry angle and a beginning and an ending scribed stroke sample.

18. An electronic device as claimed in claim 12, wherein the processor is further arranged to determine the character entry height from a centre line in a character entry direction of the received scribed stroke samples and such that the character entry scribing region encompasses all of the scribed strokes samples.

19. An electronic device as claimed in claim 12, wherein the processor is further arranged to determine the number of scribed strokes samples dependent on PI and a character entry height of a previously determined character entry scribing region.
